(19) United States
(12) Patent Application Publication
(10) Pub. No.: US 2024/0278643 A1
(43) Pub. Date: Aug. 22, 2024

(54) DYNAMICALLY AUGMENTING A VEHICLE CONTROL INTERFACE

(71) Applicant: International Business Machines Corporation, Armonk, NY (US)

(72) Inventors: Fang Lu, Billerica, MA (US); Jeremy R. Fox, Georgetown, TX (US); Tushar Agrawal, West Fargo, ND (US); Sarbajit K. Rakshit, Kolkata (IN)

(21) Appl. No.: 18/169,931

(22) Filed: Feb. 16, 2023

(51) Int. Cl. B60K 35/00

(52) U.S. Cl. CPC B60K 35/00; B60K 35/22; B60K 35/28; B60K 35/65; B60K 2360/175; B60K 2360/177

(57) ABSTRACT

A computer-implemented method generates and updates a dashboard display on an augmented reality display within a vehicle. The method includes identifying a driver of a vehicle, where the vehicle is at least partially automated. The method further includes determining a set of conditions for the vehicle. The method also includes determining a driving mode for the vehicle, where the driving mode represents a level of automation for the vehicle. The method includes analyzing, by a learning model, the set of conditions and the driving mode. The method further includes determining, in response to the analyzing, a subset of components to add to a display, where each component is selected from a set of available components associated with the vehicle. The method also includes rendering the subset of components on the display on a user interface.

### BACKGROUND

The present disclosure relates to automated vehicles, and, more specifically, to altering an augmented reality display and control function based on driving mode and conditions.

Many modern vehicles have several modes/levels of automation. These can range from no automation or fully manual, where a driver performs all tasks related to driving, through partially automated, where the driver performs some of the tasks, to fully automated, where the driver performs almost no tasks related to driving.

### SUMMARY

Disclosed is a computer-implemented method to generate and update a dashboard display on an augmented reality display within a vehicle. The method includes identifying a driver of a vehicle, wherein the vehicle is at least partially automated. The method further includes determining a set of conditions for the vehicle. The method also includes determining a driving mode for the vehicle, wherein the driving mode represents a level of automation for the vehicle. The method includes analyzing, by a learning model, the set of conditions and the driving mode. The method further includes determining, in response to the analyzing, a subset of components to add to a display, wherein each component is selected from a set of available components associated with the vehicle. The method also includes rendering the subset of components on the display on a user interface. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for generating and updating a display in a vehicle, in accordance with some embodiments of the present disclosure.

FIG. 2 is a block diagram of a computing environment suitable for operation of a display manager, in accordance with some embodiments of the present disclosure.

FIG. 3 is a flow chart of an example method to generate a display based on user preferences and driving conditions, in accordance with some embodiments of the present disclosure.

FIG. 4 is a flow chart of an example method update a display based on user preferences and a change in driving conditions, in accordance with some embodiments of the present disclosure.

FIGS. 5A-5C are illustrative screen shot examples of generating and updating a display, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as generating and updating a display in a vehicle of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

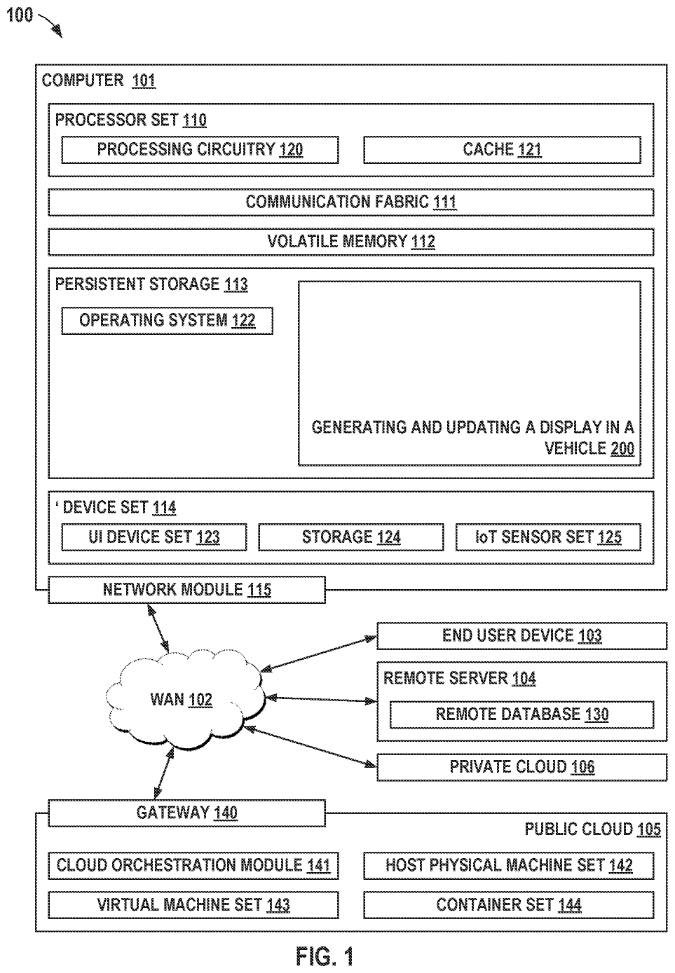

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to automated vehicles, and, more specifically, to altering an augmented reality display and control function based on driving mode and conditions.

Many modern vehicles have several modes/levels of automation. These can range from no automation or fully manual, where a driver performs all tasks related to driving, to partially automated, where the driver performs some of the tasks, to fully automated, where the driver performs almost no tasks related to driving. Many vehicles can switch between the various driving modes automatically and/or based on actions/inputs from the driver. The amount of attention the driver needs to focus on driving can be different for the different levels of automation. Many vehicles include augmented reality (AR) features that are incorporated into the vehicles. The AR screen displays information and/or projects information to various compatible surfaces within the vehicle. An augmented reality system can be any system that enhances/alters a user's perception on their surroundings. For example, a vehicle can include a Heads-Up Display (HUD), that can display driving directions within the field of view of the driver, so a driver does not need to look away from the road to gather the relevant information. In another example, the AR can include a headset or other device wearable/removable by the driver (e.g., smart glasses, virtual reality (VR) headset, etc.).

When a vehicle is in manual mode, the types of controls and data needed by the driver can be very different than when the vehicle is an automatic or self-driving mode. For example, when in automatic mode, a current speed of the vehicle that is being controlled by the driving system may be less important than when the vehicle is in manual mode, and the driver is controlling the speed of the vehicle. So, when in manual mode, the speedometer can be in a more prominent and easier to view location for the driver. Continuing the example, entertainment controls (e.g., music, etc.) may be more accessible when in an automatic mode than when in a manual mode. That way, the entertainment controls will have a smaller chance of distracting a driver currently in control of the vehicle.

Other factors that can affect the available display is the experience level and/or preferences of the driver. A driver with relatively low experience can be distracted and/or overwhelmed by a large number of controls that they are unlikely to use. Additionally, options that are not required for driving the vehicle, such as entertainment controls, may provide a distraction if they are present. Thus, in some embodiments, the entertainment controls can be removed. Further, if a user never uses a specific control, the presence of this control may cause a distraction, or the display of the control could be replaced with information more useful/preferred by the driver.

In order to better provide a dynamic and safe driving/riding experience, embodiments of the present disclosure may adjust, via an augmented reality display, the vehicle information and control options available to the driver and/or passengers.

Embodiments of the present disclosure improve the driving experience and/or safety of automobile that have at least some self-driving capabilities. Self-driving capabilities can be any action that are performed independent of an input from the current driver or passengers of the vehicle.

Embodiments of the present disclosure can include a display manager configured to generate and/or alter a dashboard display (or display, or control panel) on a vehicle. The display can include any set of information being provided to and/or controls available to a driver and/or passengers in a vehicle. In some embodiments, the vehicle includes at least some self-driving capabilities. In some embodiments, the display manager can alter the amount of information and/or controls visible to a driver of a vehicle.

In some embodiments, the display manager can identify a driver of the vehicle. The driver can select a profile, or a device (e.g., cellular device) associated with the user that can manually or automatically communicate with the vehicle. In some embodiments, each driver is associated with a driver profile and a history. The two data sets can provide inputs on user preferences, control and frequency of use of various control, typical driving times and routes, and the like. In some embodiments, the display manager can determine a driving mode. The driving mode can represent a level of automation or a level of driver control of the vehicle.

In some embodiments, the display manager can identify driving conditions. The driving conditions can be conditions inside and/or outside the vehicle. The outside conditions can be factors such as traffic, route, location, weather, road conditions, and the like. Internal conditions can include the number of passengers, and activities in car (e.g., entertainment options, conversion, etc.). The display manager can use one or more sensors and/or user inputs to determine the conditions. The sensors can be of any type and can be inside and/or outside the vehicle.

In some embodiments, the display manager can analyze the driving mode, the conditions, and the driver. The analysis can include using a learning model. The learning model can output a set of controls to add and/or remove, or to rearrange, the current display. In some embodiments, the display manager renders the display on an AR device. The display manager can monitor for changes in any of the conditions, driving mode, or user preferences, and update the display accordingly.

The aforementioned advantages are example advantages, and embodiments exist that can contain all, some, or none of the aforementioned advantages while remaining within the spirit and scope of the present disclosure.

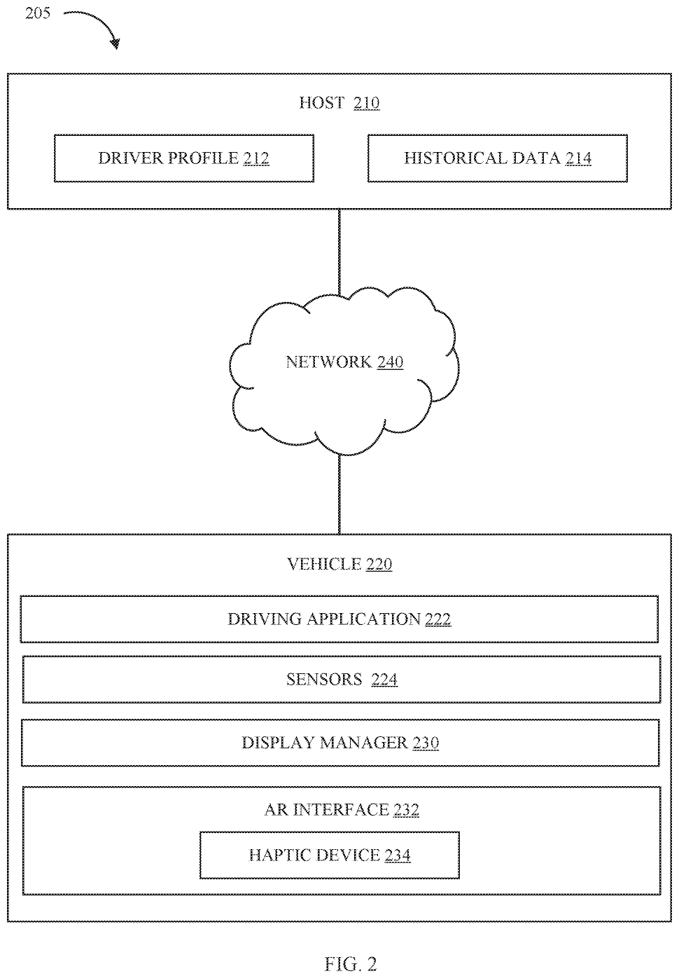

Referring now to various embodiments of the disclosure in more detail, FIG. 2 is a representation of a computing environment 205, that is capable of running a display manager in accordance with one or more embodiments of the present disclosure. Many modifications to the depicted environment may be made by those skilled in the art without departing from the scope of the disclosure.

Computing environment 205 includes host 210, vehicle 220, and network 240. Network 240 can be, for example, a telecommunications network, a local area network (LAN), a wide area network (WAN), such as the Internet, or a combination of the three, and can include wired, wireless, or fiber optic connections. Network 240 may include one or more wired and/or wireless networks that are capable of receiving and transmitting data, voice, and/or video signals, including multimedia signals that include voice, data, and video information. In general, network 240 may be any combination of connections and protocols that will support communications between and among host 210, vehicle 220, and other computing devices (not shown) within computing environment 205. In some embodiments, each of host 210, vehicle 220, and other devices not shown may include one or more a computer system, such as computer 101 of FIG. 1.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 includes driver profile 212 and historical data 214. In some embodiments, host 210 and/or any of the subcomponents of host 210 can be incorporated into and/or combined with vehicle 220. However, they are shown as separate for discussion purposes.

Driver profile 212 can include information about one or more drivers of vehicle 220. In some embodiments, driver profile 212 can include a plurality of data for a driver. In some embodiments, driver profile 212 includes two or more profiles for two or more drivers. In some embodiments, driver profile 212 is based on vehicle 220. The profile can be shared for multiple vehicles. Each particular vehicle can have data unique to that vehicle 220 related to the functionality of the vehicle and the preferences of the driver. In some embodiments, driver profile 212 can include an experience level and/or skill level for the driver. In some embodiments, driver profile 212 can include any number of unique profiles for individual drivers.

Historical data 214 can be data related to how one or more users interact with vehicle 220 and/or different vehicles. In some embodiments, historical data 214 includes driving history for each driver profile 212. The driving history can include each driving session, level of automation used, controls that are utilized, information that is viewed, manual changes to any display, environmental conditions, passenger data while driving (and changes for each other category when with passengers), and the like. The driver profile 212 can use data within historical data 214 to generate and/or update preferences, manual changes, and/or an experience level for each user profile 212 and the associated driver.

Vehicle 220 can be any engine powered vehicle. In some embodiments, vehicle 220 can be any machine that is propelled by an engine. Each vehicle can include one or more combustion and/or electric engine. The vehicle can be an automobile, a bicycle, an all-terrain vehicle, farm equipment, watercraft, and any other type of movable machine. In some embodiments, vehicle 220 has some level of automation/self-driving capability. Each vehicle can include a computing device to manage the automation of the vehicle. In some embodiments, vehicle 420 includes a driving application 222, sensors 224, display manager 230, and AR interface 232.

In some embodiments, vehicle 220 has a default display. The default display can be a starting point/default configuration for the set of information/controls displayed within vehicle 220. In some embodiments, vehicle 220 has a set of available display components. Each component in the set can be rendered on a display, and provide information to and/or receive an input from the driver or a passenger. In some embodiments, the default display can be updated by display manager 230. The updates can include adding and/or removing displayed information and control inputs. In some embodiments, a portion of the display cannot be altered. For example, vehicle 220 can be configured to always display a current speed. The location of the speed indication can be constant or variable. In some embodiments, vehicle 220 includes one or more permanent components. The permanent components can be configured to always be visible to the driver. In some cases, the permanent is always in the same location, and others it may be moved to different portions of the display.

Driving application 222 can be any combination of hardware and/or software configured to automate at least a portion of vehicle 220. The automation can be any level of automation. In some embodiments, driving application 222 can automate one or more of accelerating, decelerating, maintaining velocity, maintaining distance, steering, changing lanes, parking, and the like. In some embodiments, the driving application can manage an automated function in the vehicle unrelated to driving. This can include turning on/off attached equipment, passenger comfort actions, communications, and the like.

In some embodiments, the automobile is fully automated. When fully automated, driving application 222 performs all functions to drive the vehicle such that a passenger/driver takes no actions and vehicle 222 continues to drive without user input. In some embodiments, the level of automation is very low, such that driving application 222 can perform a single action. For example, the automation can maintain an engine at a constant revolutions per minute (RPM) and/or a constant velocity. In some embodiments, the level of automation can be any level. Any function of driving can be performed by driving application 222.

In some embodiments, driving application 222 can have preset automation levels/modes. Each level can have a set of functions that are performed by the driving application 222. The various functions are not necessarily mutually exclusive and/or additive. In some embodiments, each level builds on the next lower level by adding at least one additional function to all of the functions of the lower levels. There can be any number of predefined levels.

Sensors 224 can be any combination of hardware and/or software configured to gather data within and/or surrounding a vehicle 220. Vehicle 220 can include any number sensors and any number of types of sensors. In some embodiments, the type of sensor includes one or more of cameras, thermometers, heat detectors, moisture detectors, motion detections, microphones, distance detectors, and the like. The number and type of sensors can be configured to gather enough data to identify environmental and traffic conditions outside the vehicle, and the number of passengers and/or other relevant information from inside the vehicle. In some embodiments, the various sensors can be placed in various locations around and within the vehicle. In some embodiments, data from sensors 224 can be sent to display manager 230. In some embodiments, the data from sensors 224 can be used to determine conditions changes inside and outside the vehicle.

Display manager 230 can be any combination of hardware and/or software configured to manage content that is displayed to a driver. The content can be to provide information to the driver/passengers and/or control input for driving and entertainment functions. In some embodiments, display manager 230 can alter the view of a dashboard in a vehicle. The alteration can include adding and/or removing items from the display. In some embodiments, the alterations are based on one or more of driving mode, driving conditions, location, number of people in vehicle 220, context within vehicle 220, driver profile 212, and historical data 214.

In some embodiments, display manager 230 can identify a driving mode of vehicle 220. The driving mode can be based on the amount of automation of vehicle 220. In some embodiments, the driving mode is selected from a predetermined set of modes. The predetermined set of modes can have any number of options. For example, an option can be binary, such as manual or automatic. In another example, there can be several options, where each unique combination of automated options makes a unique driving mode. In some embodiments, display manager 230 can calculate a mode score. The mode score, or driving mode score, can be a representation of the level of automation. Display manager 230 can analyze the current settings to determine the driving mode and/or the inputs to the mode score. In some embodiments, the driving mode is determined in response to an input from the driver indicating/switching between modes. In some embodiments, the mode score can be correlated with display components. For example, if the mode score represents a high level of automation (or a low level of manual operation), the components can be more centered on entrainment and less on driving controls and vehicle information. But when the mode score represents a low level of automation (or a high level of manual operation), the display components can be focused on vehicle safety and control, and attempt to limit distractions to the driver.

In some embodiments, display manager 230 can determine driving conditions. Driving conditions can affect the driving mode and/or the mode score. Driving conditions can be conditions inside the vehicle and/or outside the vehicle. In some embodiments, the driving conditions can be any conditions that can potentially affect the driver, or the driving mode, or operation of vehicle 220. Outside conditions can be environmental (e.g., weather, road conditions, etc.), location, type of road, destination, time of day, traffic, and the like. In some embodiments, display manager 230 can obtain outside-the-vehicle conditions from one or more sensors 224. Sensors 224 can identify road conditions (e.g., wet vs. dry, etc.), traffic, surroundings (e.g., city driving vs. highway driving, etc.), potential distractions (e.g., billboards, pedestrians, etc.), light (e.g., darkness, glare, etc.), and the like. In some embodiments, the inside driving conditions can be determined by internal sensors 224. The internal sensors can identify the number of passengers, conversations, activities (e.g., kids in back seat drawing, etc.), and the like. In some embodiments, the time of day can be a driving condition.

In some embodiments, display manager 230 can determine the location of vehicle 220. The location can affect the driving mode and/or the mode score. In some embodiments, the location can affect the display. In some embodiments, determining the location can include determining a starting point and a destination for the drive. The length of the drive can also have an effect on the driving mode and/or the display. In some embodiments, the location is determined by a global positioning system (GPS) within vehicle 220, AR interface 232, and/or on another device associated with the driver or a passenger of vehicle 220.

In some embodiments, display manager 230 can use any number of factors to determine the driving conditions. In some embodiments, the factors can be analyzed in light of the driver profile 212 and historical data 214 as an input into driving mode/mode score. For example, if a driver is driving late at night, it can have an effect on a mode score to limit distractions. However, if the same driver frequently drives the same route around the same time, then the effect on the mode score can be different.

In some embodiments, display manager 230 can identify a set or subset of display components based on the conditions. Each component can portray data about the vehicle to the driver and/or receive an input to change a feature (control of the vehicle, or within the vehicle). In some embodiments, vehicle 220 has a set of display components available. The set can be based on functionality of vehicle 220 and/or the capabilities of AR interface 232 to render and display the component.

In some embodiments, display manager 230 uses a learning model, or machine learning, to identify the subset of components to display. The learning model can be trained based the historical data and/or safety data. The training data can be related to driving application 222, driver profile 212, historical data 214, and the like. Data from several different vehicles and profiles can be combined to better train the model.

In some embodiments, the inputs to the learning model can include driving conditions and driver information (e.g., driver profile 212, historical data 214). The output can include the subset of components to display, including locations and size. In some embodiments, the input may include the current display, and the output can include which components to remove and/or rearrange in size and/or location.

In some embodiments, display manager 230 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, display manager 230 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

In some embodiments, display manager 230 updates the vehicle display. In some embodiments, the updates are based on a combination of any of driving conditions, location, route, driving mode, mode score, driver profile 212, historical data, 214, driver input, capabilities of vehicle 220, AR interface 232, and the like. Display manager 230 analyzes the input data to generate/alter the display. Each display can be configured to present a set of controls and information based on mode and driver preferences. In some embodiments, display manager 230 communicates with AR interface 232 to update the display. The update can include adding, removing, and/or rearranging the display.

AR interface 232 can be any combination of hardware and/or software configured to display visual information to the driver and other passengers of vehicle 220. In some embodiments, AR interface 232 can use visual, audio, and/or other computer sensory-generated data to enhance provide data and/or control options to occupants of vehicle 220. In some embodiments, AR interface 232 can include one or more separate displays. Each display can portray information and/or receive input. In some embodiments, the one or more displays are embedded into vehicle 220. For example, a smart windshield of a display screen can be part of AR interface 232. In some embodiments, the one or more displays can be on a separate AR device.

AR interface 232 can be overlayed on any surface (e.g., windshield, display screen, etc.) within vehicle 220. In some embodiments, AR interface 232 can accept input from one or more passengers within vehicle 220. In some embodiments, AR interface 232 can include one or more wearable devices. The wearable devices can be added to, and removed from, people within vehicle. The wearable devices can include glasses (e.g., smart glasses, headsets, attachments from extremities, and the like). In some embodiments, AR interface 232 includes a combination of wearable devices and/or surfaces on/within vehicle 220. In some embodiments, AR interface 232 includes haptic device 234.

Haptic device 234 can be any combination of hardware and/or software configured to provide physical sensation to the user. Haptic device 234 can include vibrating, pressure, and the like. Haptic device 234 can be integrated with AR interface 232 in the wearable device and/or into vehicle 220 (e.g., vibration on steering wheel or seat, etc.).

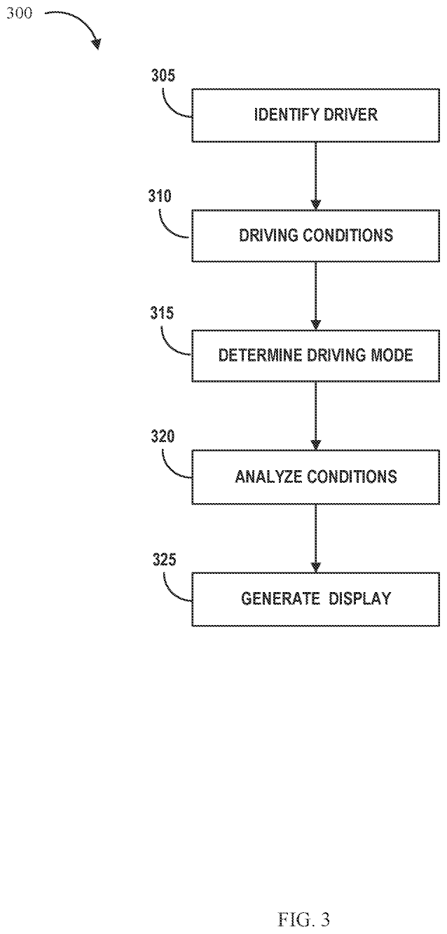

FIG. 3 is a flowchart of an example process 300 for generating a display in a vehicle that can be performed in a computing environment (e.g., computing environment 100 and/or computing environment 205). One or more of the advantages and improvements described above for updating a display in a vehicle may be realized by process 300, consistent with various embodiments of the present disclosure.

Process 300 can be implemented by one or more processors, host 210, driver profile 212, historical data 214, vehicle 220, driving application 222, sensors 224, display manager 230, AR interface 232, haptic device 234, and/or a different combination of hardware and/or software. In various embodiments, the various operations of process 300 are performed by one or more of host 210, driver profile 212, historical data 214, vehicle 220, driving application 222, sensors 224, display manager 230, AR interface 232, and haptic device 234. For illustrative purposes, the process 300 will be described as being performed by display manager 230.

At operation 305, display manager 230 identifies a driver of vehicle 220. The identification can be based on an input from the driver. For example, the driver can select a profile/setting after entering the vehicle. In some embodiments, the identification is based on one or more sensors 224. The one or more sensors 224 can be configured to identify the driver based on biometrics, voice, and the like. In some embodiments, the identification can be based on AR interface 232. AR interface 232 can be associated with a driver and connect automatically and/or manually to vehicle 220. The connections can be physically removable connection and/or a wireless connection (e.g., Bluetooth®, etc.).

In some embodiments, operation 305 includes retrieving/receiving driver data from driver profile 212 and/or historical data 214. The received data can include driver preferences and/or history from the specific and/or similar vehicles related to the display options.

At operation 310, display manager 230 identifies driving conditions. The driving conditions can be any conditions from inside and/or outside the vehicle. In some embodiments, the conditions include outside/environmental conditions. Vehicle 220 can determine the conditions from sensors 224. The conditions can include route (e.g., starting point, destination, etc.), environmental conditions, road conditions, traffic, and the like.

At operation 315, display manager 230 determines a driving mode. The driving mode can represent a level of automation of vehicle. In some embodiments, determining the driving mode includes calculating the mode score.

At operation 320, display manager 230 analyzes the driver information, the driving conditions, and the driving mode. In some embodiments, the analysis is performed by one or more learning models. Any or all of the data points gathered in operation 305-315 can be inputs into the learning model. Additional inputs can include a default display for vehicle 220, and other policies (e.g., safety policies for required display and control—for example, speed control must always be available on the display.). In some embodiments, the analysis can determine, from an available set of data and controls, a subset to render. For example, in wet road conditions, a display representing how well the tires are gripping the road may be in the subset, but in dry weather the same display may not be in the subset.

Additionally, the analysis can determine/rank a prominence/size and/or location for each item in the subset. The subset can include data that is likely to be useful based on the conditions. For example, if vehicle 220 is in self diving mode (or a cruise control) the current speed may be smaller and on the peripheral of the display; but when the driver is controlling the speed, or the speed may be changing, the speed may be large and easy for the driver to see.

At operation 325, display manager 230 generates the display. In some embodiments, the generating can include modifying the display from a default. In some embodiments, the generation is based on the results of the learning model, the identified driving conditions, the identified driving mode, and the analysis. In some embodiments, AR display 232 can render and/or remove any parts of the display based on the analysis and data received from display manager 230. The display surfaces can be embedded in vehicle 220 (e.g., display screen) and/or on a display for a separate AR device. In some embodiments, the display can use a non-connected AR display 232 to block out a gauge or control designed into vehicle 220. For example, a driver can be wearing smart glasses, and the smart glasses obscure a specific control knob in order to view the rest of the dashboard. Thus, to the driver, it appears as if the control know is not present in the vehicle.

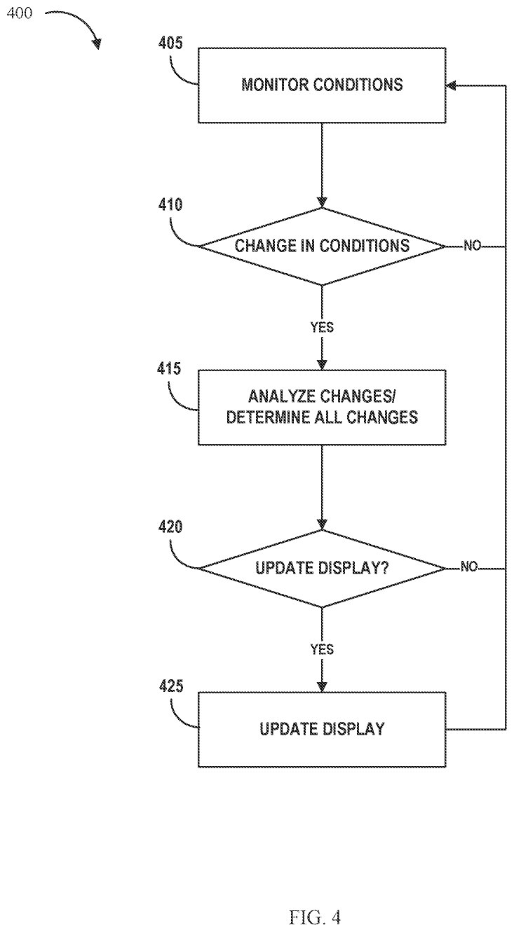

FIG. 4 is a flowchart of an example process 400 for updating a display in a vehicle based on a change in conditions that can be performed in a computing environment (e.g., computing environment 100 and/or computing environment 205). One or more of the advantages and improvements described above for updating a display in a vehicle based on a change in conditions may be realized by process 400, consistent with various embodiments of the present disclosure.

Process 400 can be implemented by one or more processors, host 210, driver profile 212, historical data 214, vehicle 220, driving application 222, sensors 224, display manager 230, AR interface 232, haptic device 234, and/or a different combination of hardware and/or software. In various embodiments, the various operations of process 400 are performed by one or more of host 210, driver profile 212, historical data 214, vehicle 220, driving application 222, sensors 224, display manager 230, AR interface 232, and haptic device 234. For illustrative purposes, the process 400 will be described as being performed by display manager 230.

At operation 405, display manager 230 monitors driving conditions and/or the driving mode. In some embodiments, display manager 230 continuously and/or periodically monitors for changes to driving conditions. The monitored conditions can be any conditions or analysis inputs from operations 305-315. In some embodiments, the periodic checks can be based on one or more triggers. The triggers can include time, distance traveled, received input, and the like.

At operation 410, display manager 230 determines if there is a change in any conditions. In some embodiments, display manager 230 determines there are changes if any conditions changes, or if inputs into the analysis change. In some embodiments, display manager 230 determines a condition changed if the specific change exceeds a threshold (e.g., changes by 10%). Various inputs can have different thresholds for indicating a change in conditions. For example, a threshold for a first condition can be any change (or a relatively small absolute change), while a threshold for a second condition can be relatively large and/or in a particular direction (non-absolute, directional). If display manager 230 determines there is a change in conditions (410:YES), then display manager 230 proceeds to operation 415. If display manager 230 determines there is no change in conditions (410:NO), then display manager 230 returns to operation 405.

At operation 415, display manager 230 analyzes the inputs and the changed conditions or changed driving mode. In some embodiments, operation 415 can be consistent with operation 320 from process 300.

At operation 420, display manager 230 determines if the display needs an update based on the changed conditions. In some embodiments, the determination is based on the results of operation 415. Display manager 230 can compare the results of the analysis to the current display. Any differences in the suggested/recommended or the arrangement of the components can indicate a change is needed. In some embodiments, display manager 230 assumes or is instructed to change the display to the new results. However, it may be possible that the new rendering is identical to the old rendering, and, thus, no changes appear, or the changes were not needed. If it is determined that changes are needed (420:YES), then display manager 230 proceeds to operation 425. If it is determined that no changes are needed (420:NO), then display manager 230 returns to operation 405.

At operation 425, display manager 230 updates the display. Operation 425 can be consistent with operation 325 of process 300, with the exception that starting point may be different. The starting point of the change can be the current display, whether it is the result of default or the result of method 330 or a previous iteration of method 400. In some embodiments, display manager 230 returns to operation 405 in response to completing the update on AR interface 232. Display manager 230 can continue to perform the method 400 until the vehicle is no longer in operation.

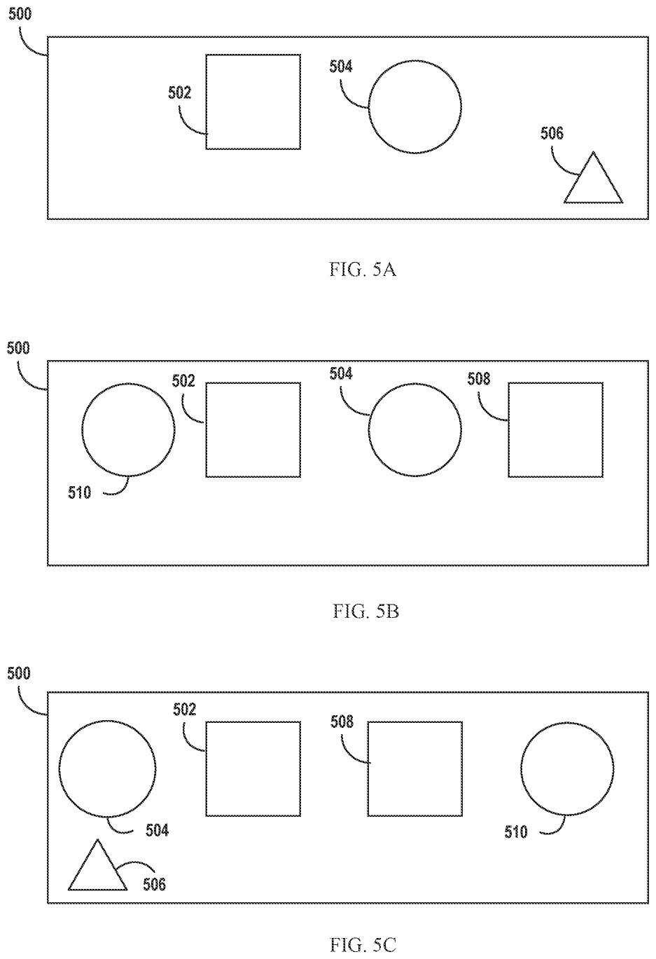

FIGS. 5A-5C include example embodiments of an AR display 232 showing display components. FIG. 5A includes display 500 component 502, component 504, and component 506. The portion of AR interface 232 associated with display 500 can be embedded into vehicle 220 and/or in a separate AR device (e.g., smart glasses). In some embodiments, each component can be a default and/or identified as needed/preferred for the identified driving conditions and driver preferences.

FIG. 5B includes display 500 component 502, component 504, component 508, and component 510. For example, the update between FIGS. 5A and 5B can be based on a change of conditions that determined component 506 is unneeded, not useful, and/or distracting, while determining component 510 and component 508 are needed and/or useful. One example can be that the road condition changed from wet to dry. While the road condition is wet in FIG. 5A, component 506 represents tire traction. Once the road is dry, in FIG. 5B, then component 506 becomes clutter and is very unlikely to be useful. The added components may have increased a likelihood of distraction or dangerous maneuver on a wet road, but do not pose a danger associated with the dry road of FIG. 5B.

FIG. 5C includes display 500 component 502, component 504, component 506, component 508, and component 510. However, all components, except component 502, have an adjusted position on the display. The update can be based on a condition change making it so that one or more components is occupying a prime and/or peripheral location. In this example, component 502 can be configured to always be present at the same location as shown in FIG. 5A-5C.

Embodiments of the present disclosure can improve the driver experience and the safety of at least partially automated vehicle. By dynamically and automatically updating and generating a unique interface based on the unique set of conditions and driver preferences, the display manager improves the driving experience and reduces a likelihood of bad events while driving. Further, the display manager can eliminate unnecessary or non-useful display components from a display thereby saving processing power and storage for relevant items based on the identified driving conditions.

### Computer Technology and Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying a driver of a vehicle, wherein the vehicle is at least partially automated;
determining a set of conditions for the vehicle;
determining a driving mode for the vehicle, wherein the driving mode represents a level of automation for the vehicle;
analyzing, by a learning model, the set of conditions and the driving mode;
determining, in response to the analyzing, a subset of components to add to a display, wherein each component is selected from a set of available components associated with the vehicle; and
rendering the subset of components on the display on a user interface.

2. The computer-implemented method of claim 1, wherein the set of conditions includes external conditions outside the vehicle and internal conditions.

3. The computer-implemented method of claim 2, wherein the external conditions include weather, road conditions, traffic, road type, and location.

4. The computer-implemented method of claim 1, further comprising:
obtaining, in response to the identifying the driver, a profile for the driver including driver preferences and a driving history for the driver.

5. The computer-implemented method of claim 1, wherein the rendering occurs on an augmented reality (AR) interface.

6. The computer-implemented method of claim 5, wherein the AR interface is embedded into the vehicle.

7. The computer-implemented method of claim 5, wherein the AR interface is on an AR device communicatively connected to the vehicle.

8. The computer-implemented method of claim 1, wherein the set of components includes display components configured to portray data about the vehicle to the driver and control components configured to allow the driver to adjust a function of the vehicle.

9. The computer-implemented method of claim 1, further comprising:
monitoring, in response to the rendering, the set of conditions;
determining a change in at least one condition of the set of conditions; and
updating, in response to the change, the subset of components, wherein the updating changes the subset of components.

10. The computer-implemented method of claim 1, wherein the vehicle includes a default subset of components and the determining the subset of components alters the default subset.

11. A system comprising:
a processor; and
a computer-readable storage medium communicatively coupled to the processor and storing program instructions which, when executed by the processor, are configured to cause the processor to:
identify a driver of a vehicle, wherein the vehicle is at least partially automated;
determine a set of conditions for the vehicle;
determine a driving mode for the vehicle, wherein the driving mode represents a level of automation for the vehicle;
analyze, by a learning model, the set of conditions and the driving mode;
determine, in response to the analyzing, a subset of components to add to a display, wherein each component is selected from a set of available components associated with the vehicle; and
render the subset of components on the display.

12. The system of claim 11, wherein the set of conditions includes external conditions outside the vehicle and internal conditions.

13. The system of claim 12, wherein the external conditions include weather, road conditions, traffic, road type, and location.

14. The system of claim 11, wherein the program instructions stored on the computer-readable storage medium are further configured to cause the processor to:
obtain, in response to the identifying the driver, a profile for the driver including driver preferences and a driving history for the driver.

15. The system of claim 11, wherein the rendering occurs on an augmented reality (AR) interface.

16. A computer program product, the computer program product comprising a computer readable storage medium having program instructions embodied therewith, the program instructions executable by a processing unit to cause the processing unit to:
identify a driver of a vehicle, wherein the vehicle is at least partially automated;
determine a set of conditions for the vehicle;
determine a driving mode for the vehicle, wherein the driving mode represents a level of automation for the vehicle;
analyze, by a learning model, the set of conditions and the driving mode;
determine, in response to the analyzing, a subset of components to add to a display, wherein each component is selected from a set of available components associated with the vehicle; and
render the subset of components on the display.

17. The computer program product of claim 16, wherein the set of conditions include external conditions outside the vehicle and internal conditions.

18. The computer program product of claim 17, wherein the external conditions include weather, road conditions, traffic, road type, and location.

19. The computer program product of claim 16, wherein the program instructions are further configured to cause the processing unit to:
obtain, in response to the identifying the driver, a profile for the driver including driver preferences and a driving history for the driver.

20. The computer program product of claim 16, wherein the rendering occurs on an augmented reality (AR) interface.
